(19) United States
(12) Patent Application Publication
(10) Pub. No.: US 2004/0008697 A1
(43) Pub. Date: Jan. 15, 2004

(54) Method and apparatus for enabling filtering of data packets

(75) Inventors: Paul C. Millard, Eastleigh (GB); Kathryn E. Rickard, Romsey (GB)

Correspondence Address: PILLSBURY WINTHROP, LLP, P.O. BOX 10500, MCLEAN, VA, 22102, US

(73) Assignee: XYRATEX TECHNOLOGY LIMITED, Hampshire (GB)

(21) Appl. No.: 10/437,463

(22) Filed: May 14, 2003

Related U.S. Application Data
(60) Provisional application No. 60/380,289, filed on May 15, 2002.

(51) Int. Cl. H04L 12/28

(52) U.S. Cl. 370/397; 370/392

(57) ABSTRACT

In a method for enabling filtering of data packets passing along a data link (10), each data packet to be filtered includes connection data relating to the source of the data packet and the destination of the data packet. For at least some of the data packets passing along a data link, the connection data of the data packets is compared in a hardware logic device (24) with connection data stored in the hardware logic device (24). A positive evaluation result is generated for any packet for which the connection data of the data packet matches any of the connection data stored in the hardware logic device (24), whereby the data packet can be filtered. For a packet whose connection data does not match connection data that has been previously stored in the hardware logic device (24), connection data for the packet is preferably added to the connection data stored in the hardware logic device (24). The hardware logic device (24) may be a content addressable memory (CAM).

### BACKGROUND OF THE INVENTION

1. Field of the Invention

This application claims priority to U.S. provisional application No. 60/380,289, the entire content of which is hereby incorporated by reference.

The present invention relates to a method and apparatus for enabling filtering of data packets.

2. Description of the Related Art

The present invention has particular applicability to the field of ATM network analysis.

As is well known, data can be transmitted in the form of discrete data packets or information cells over a transmission link. The data transmitted may be voice, video or any other type of data.

Network test equipment monitors links, collecting statistics and capturing packets of data to a buffer for analysis. It is usually necessary to select the data of interest in order to prevent the capacity of the statistics monitoring process or the capacity of the capture buffer being exceeded. The method of selecting data packets of interest and discarding others is known in the art as “filtering”. One criterion by which data packets are filtered is by connection. A connection can be defined as the message exchange between two nodes and can be identified by connection data that includes or consists of a pair of addresses: the source address and the destination address.

One network technology that uses data packets or information cells is ATM (Asynchronous Transfer Mode), which is a cell-switched technology in wide use over the present cabled backbone technology. Each frame of data to be transmitted is typically split into plural data packets (or “cells” in the terminology of ATM), each being a fixed sized unit of 53 bytes. 48 bytes of the ATM cell is used to carry the data itself. The remaining 5 bytes are used as a header. The transmission links are typically shared between many users, with cells from the plural sources being interleaved on each link. The advantages of ATM in particular include increased efficiency of data transmission and speed of data transmission. Moreover, ATM provides a means of guaranteeing a certain transmission capacity to certain users and to do so on-demand. Thus, some users (or other connections) can have more bandwidth allocated than others on the same transmission system. This is known as “traffic shaping”.

ATM networks use the concept of virtual circuits. A single physical transmission link is subdivided into virtual paths (VP), which are further subdivided into virtual channels (VC). Presently, typical ATM networks allow a physical transmission link to be subdivided into a maximum of 4096 virtual paths, and each virtual path may be further subdivided into a maximum of 65,536 virtual circuits. In an ATM network, the connection data or address pair are known as the virtual path identifier (VPI) and the virtual circuit identifier (VCI) and such connection data is carried by each data packet in its header.

The active connections on a link of any network are in general constantly changing, and therefore the filter of a network monitor is required to change dynamically dependent on the current traffic. This is particularly the case with an ATM network because of its flexible treatment of data packets and the fact that, as a result, any particular connection constantly changes between being active and inactive.

U.S. Pat. No. 6,252,872 discloses a data packet filter that uses one or more content addressable memories (CAMs). Pre-defined data packets of interest are identified by the filter using a combination of plural CAMs to match pre-defined data patterns at particular byte positions within the frame. The disclosed method and apparatus requires software control over the process of identifying what patterns should be configured in the CAMs in order to identify data packets of interest. This in turn requires that the process either has an implied pre-knowledge of what is on the link, which may not be valid, or a latency involved in discovering what is on the link and then setting appropriate filters, which may cause one or more relevant data packets to be missed.

U.S. Pat. No. 6,195,352 discloses a method and apparatus for identifying and analysing currently active channels in an ATM network. In combination with hardware, software is used to perform the processing of received cells to add connection data to a software-controlled connection table. Even with the relatively high processor speeds currently available, the identification of the data packets of interest through the use of software leads to slow performance and latency in the discovery of new connections. This in turn means that this prior art arrangement is not dynamic to capture the first data packets on a connection, which again may result in relevant data packets being missed. Whilst this software-based approach may be acceptable for transmission links that have a low traffic rate, this approach is not suitable where the throughput of data packets is rather higher.

### SUMMARY OF THE INVENTION

According to a first aspect of the present invention, there is provided a method for enabling filtering of data packets passing along a data link, wherein each data packet to be filtered includes connection data relating to the source of the data packet and the destination of the data packet, the method comprising: for at least some of said data packets passing along a data link, comparing in a hardware logic device the connection data of the data packets with connection data stored in the hardware logic device; and, generating a positive evaluation result for any packet for which the connection data of said data packet matches any of the connection data stored in the hardware logic device, whereby said data packet can be filtered.

The term “data packet” as used herein is to be construed broadly and is to be taken to include reference to what are often called “cells” in the terminology of ATM.

The term “filter” is used by those skilled in the art in a number of ways, to mean the discarding of unwanted data packets, the keeping of wanted data packets, or both. In the present specification, the term “filter” is principally, though not necessarily exclusively, used to imply the keeping of wanted data packets.

The present invention enables data packets to be filtered with little or substantially no latency as no processor operation, acting under software, is required, at least for the important comparison step. There is no requirement for a pre-knowledge of what data is on the link and particularly of which connections are active. This in turn means that filtering can take place on receipt of the first data packet from a particular connection and thus the risk of missing data packets is minimised.

The method preferably comprises, for a packet whose connection data does not match connection data that has been previously stored in the hardware logic device, adding connection data for said packet to the connection data stored in the hardware logic device.

This process, referred to herein as “auto-discovery”, means that new connections can be automatically added to the hardware logic device. This is preferably a hardware-driven process. It will be understood from the following detailed description however that a particular connection may be excluded such that data packets on that connection are not filtered. Moreover, in practice, the hardware logic device may fill up with stored connection data, meaning that new connections are effectively excluded, at least until storage space in the hardware logic device becomes free. Where, as in the most preferred embodiment, the hardware logic device comprises a content addressable memory (CAM), auto-discovery can be carried out using the “Learn” mode of the CAM.

The method preferably comprises generating an evaluation result for a packet whose connection data does not match connection data that has been previously stored in the hardware logic device and for which connection data has as a result been added to the connection data stored in the hardware logic device. The evaluation result may be “positive” as in the case of a packet whose connection data does match connection data that has been previously stored in the hardware logic device. Alternatively, a different evaluation result may be provided for a packet whose connection data does not match connection data that has been previously stored in the hardware logic device, which allows a distinction to be made between such packets (which represent a new connection) and those for which the connection data does match connection data that has been previously stored in the hardware logic device.

At least some memory space of the hardware logic device may be initially reserved, and the method may comprise saving connection data to some of said initially reserved memory space. In this embodiment, some space in the hardware logic device is reserved for future “directed-mode discovery”, i.e. the identification of particular connections, which are typically user-selected. Directed-mode discovery is typically a software-driven process.

The method may comprise removing from the hardware logic device at least some of the connection data stored therein. This enables unwanted connections, e.g. inactive connections, to be removed, thus freeing space in the hardware logic device.

In a preferred embodiment, the step of generating an evaluation result for a packet comprises tagging said data packet with a corresponding descriptor. The descriptor may include address data for the connection data stored in the hardware logic device that corresponds to the connection data of said data packet. That address data may be the logical address of the connection data in the hardware logic device. The connection data may be connection data already stored in the hardware logic device prior to the compare being carried out or may be connection data that is subsequently stored in the hardware connection device in the case of no match being found in the compare step.

In a most preferred embodiment, the hardware logic device comprises a content addressable memory (CAM). As is discussed further below, a CAM has several advantages and features that make it particularly useful as a hardware logic device in the context of the present method and apparatus.

The data packets may comprise ATM (asynchronous transfer mode) packets and the connection data may comprise a virtual channel and a virtual circuit address pair. It will be understood however that the present invention can be applied to other protocols, having different types of connection data, such as the source and destination address pair used in Ethernet networks or Fibre Channel.

According to a second aspect of the present invention, there is provided a method of filtering of data packets passing along a data link, wherein each data packet to be filtered includes connection data relating to the source of the data packet and the destination of the data packet, the method comprising: capturing one of the data packets; comparing in a hardware logic device the connection data of the captured data packet with connection data stored in the hardware logic device; and, if the connection data of said data packet matches any of the connection data stored in the hardware logic device, tagging the captured data packet with a corresponding descriptor; or if the connection data of said data packet does not match any of the connection data stored in the hardware logic device, adding the connection data of said data packet to the hardware logic device and tagging the captured data packet with a corresponding descriptor.

At least some memory space of the hardware logic device may be initially reserved, and connection data may be saved to some of said initially reserved memory space. Again, in this embodiment, some space in the hardware logic device is reserved for future “directed-mode discovery”.

The method may comprise removing from the hardware logic device at least some of the connection data stored therein. This again enables unwanted connections, e.g. inactive connections, to be removed.

In a most preferred embodiment, the hardware logic device comprises a content addressable memory (CAM).

The data packets may comprise ATM (asynchronous transfer mode) packets and the connection data comprises a virtual channel and a virtual circuit address pair. Again, it will be understood that the present invention can be applied to other protocols, having different types of connection data, such as the source and destination address pair used in Ethernet networks or Fibre Channel.

According to a third aspect of the present invention, there is provided apparatus for enabling filtering of data packets passing along a data link, wherein each data packet to be filtered includes connection data relating to the source of the data packet and the destination of the data packet, the apparatus comprising: a hardware logic device for storing connection data; a connection data extractor for extracting connection data from a data packet passing along a data link; the hardware logic device being constructed and arranged to compare the extracted connection data with connection data stored in the hardware logic device; and, a result generator constructed and arranged to generate a positive evaluation result for any packet for which the connection data of said data packet matches any of the connection data stored in the hardware logic device, whereby said data packet can be filtered.

The hardware logic device is preferably constructed and arranged to add to the connection data stored in the hardware logic device connection data for a packet whose connection data does not match connection data that has been previously stored in the hardware logic device.

The hardware logic device is preferably constructed and arranged to generate an evaluation result for a packet whose connection data does not match connection data that has been previously stored in the hardware logic device and for which connection data has as a result been added to the connection data stored in the hardware logic device. Again, the evaluation result may be “positive” as in the case of a packet whose connection data does match connection data that has been previously stored in the hardware logic device. Alternatively, a different evaluation result may be provided for a packet whose connection data does not match connection data that has been previously stored in the hardware logic device

The hardware logic device may be constructed and arranged so that at least some memory space of the hardware logic device can initially be reserved such that connection data can subsequently be saved to some of said initially reserved memory space.

The result generator is preferably constructed and arranged to tag a data packet with a corresponding descriptor to indicate a positive evaluation result for said packet if the connection data of said data packet matches any of the connection data stored in the hardware logic device. The result generator may be constructed and arranged such that the descriptor that is tagged to a data packet includes address data for the connection data stored in the hardware logic device that corresponds to the connection data of said data packet.

The hardware logic device preferably comprises a content addressable memory (CAM).

According to a fourth aspect of the present invention, there is provided apparatus for filtering of data packets passing along a data link, wherein each data packet to be filtered includes connection data relating to the source of the data packet and the destination of the data packet, the apparatus comprising: a device constructed and arranged to capture one of the data packets; a hardware logic device in which connection data can be stored, the hardware logic device being constructed and arranged to compare the connection data of the captured data packet with connection data stored in the hardware logic device; and, a data packet tagging device constructed and arranged to tag a captured data packet with a corresponding descriptor if the connection data of said captured data packet matches any of the connection data stored in the hardware logic device, and to add the connection data of a captured data packet to the hardware logic device and to tag said captured data packet with a corresponding descriptor if the connection data of said captured data packet does not match any of the connection data stored in the hardware logic device.

The hardware logic device may be constructed and arranged so that at least some memory space of the hardware logic device can initially be reserved such that connection data can subsequently be saved to some of said initially reserved memory space.

The hardware logic device preferably comprises a content addressable memory (CAM).

### BRIEF DESCRIPTION OF THE DRAWINGS

Embodiments of the present invention will now be described by way of example with reference to the accompanying drawings, in which:

FIG. 1 is a schematic circuit diagram of an example of apparatus according to an embodiment of the present invention;

FIG. 2 shows schematically the organisation of a content addressable memory which may be used in an embodiment of the present invention;

FIG. 3 shows schematically the allocation of connection data for a new connection to a CAM in accordance with a preferred embodiment of the present invention;

FIG. 4 schematically shows use of a mask in an example of an auto-discovery process in accordance with a preferred embodiment of the present invention;

FIG. 5 shows schematically use of a mask to reserve space in a hardware logic device in accordance with a preferred embodiment of the present invention; and,

FIG. 6 shows schematically division of a hardware logic device into two regions, one containing a main connection table and the other containing data for excluded connections, in accordance with a preferred embodiment of the present invention.

### DETAILED DESCRIPTION

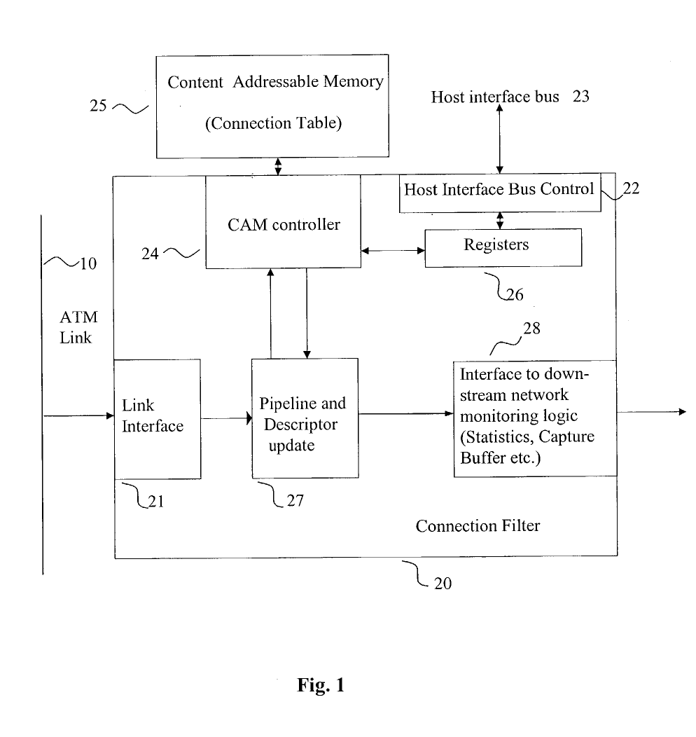

Referring first to FIG. 1, a transmission link 10 is schematically shown. In use, data packets pass along the link 10, either in one direction only or in both directions. In the specific example described herein, the link uses asynchronous transfer mode (ATM), for which the data packets are by convention known as “cells”. However, as will be appreciated, the present invention can be applied to other types of connection data, such as the source and destination address pair used in Ethernet networks or Fibre Channel.

A connection filter 20 is connected to the link 10. The connection filter 20 is preferably in the form of dedicated hardware, such as a field-programmable gate array (FPGA) or an application-specific integrated circuit (ASIC). The filter 20 includes a link interface 21 which provides the interface to the link 10. The filter 20 is connected via a host interface bus control 22 to a host interface bus 23 which connects the filter 20 to a host computer (not shown). The host computer includes software for overall control of the filter process, as will be discussed further below.

The filter 20 further includes a content addressable memory (CAM) controller 24 which is used to provide control of a CAM 25 which is connected to the filter 20. The CAM controller 24 is connected to the host interface bus control 22 via a number of memory registers 26.

In use, data packets or cells passing along the link 10 are captured by the link interface 21 and temporarily stored or “pipelined” in a pipeline portion 27 of the filter 20. Connection data is then extracted from the data packet. As described above, the connection data may be an address pair carried in a header of the data packet. This may be the source and destination address pair of the data packet. In the case of ATM data packets, the address pair which is extracted is the virtual path and virtual channel address pair. The connection data is passed by the CAM controller 24 to the CAM 25. In practice, because it is usually desirable not to affect the data flow along the link 10, it is usual to make a copy of the data packet and the copy is used for monitoring purposes with the original data packet continuing along the link 10, or vice versa. Thus, reference to capture of a data packet is to be construed to include capture and copy of a data packet so that the original data flow along the link 10 is in essence unaffected by the monitoring process.

CAMs are well known in themselves. They were principally designed for use as address filters or translators in routers or switches. A CAM is a memory of the type that can store a series of data values. Each data value is stored in a corresponding register, also referred to as an entry. The input data, or comparand, is compared against the contents of the CAM to determine if a match exists. When a match occurs, an output signal is issued by the CAM to indicate the match; the address of the matched entry in the CAM is also available. If a match is not found, an output signal provided by the CAM indicates the failure; as will be discussed further below, it is also possible for the CAM to add data to a new entry (if available) in a Learn instruction if no match is found.

In the context of the present invention, the CAM 25 is used to build a connection table, which enables connection filtering. A so-called ternary CAM can be used, which allows each compare word to be bit-masked individually. This can be useful if blocks of connections, such as sequential connections, are to be identified rather than individual connections. Otherwise, a CAM that only supports global masks is sufficient.

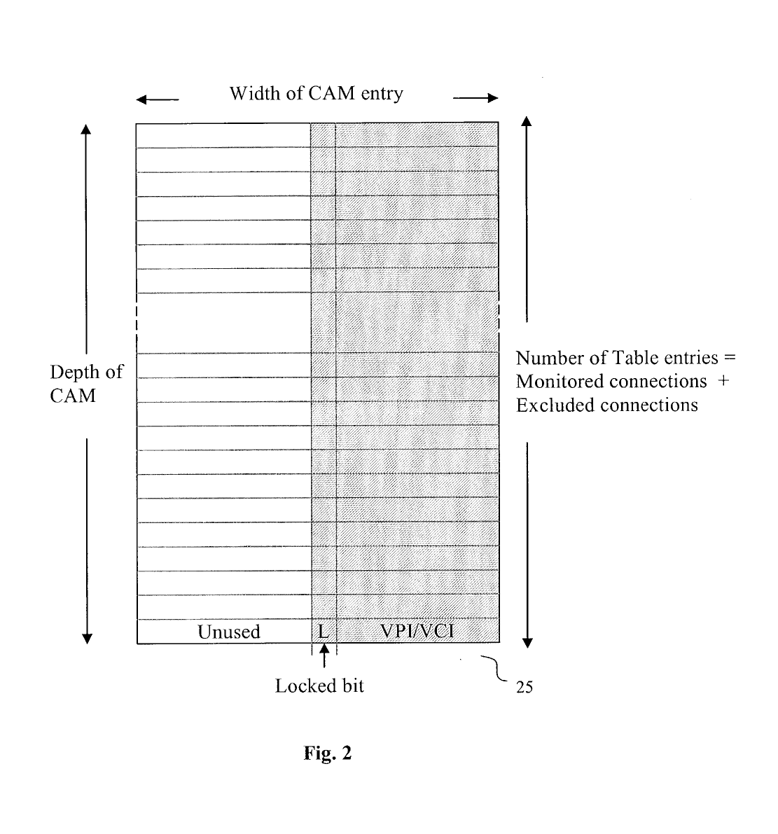

The CAM 25 used preferably has sufficient capability to store the full width of the connection data plus an additional bit used as a lock indicator (as discussed further below) for each of the required number of connections entries. In the specific example described herein, the VPI/VCI address pair is 32 bits wide. The required number of connections in the preferred embodiment is the sum of the number of connections to be monitored and the number of connections or blocks of connections to be excluded (as discussed further below). It will be appreciated that if the ability to exclude connections or blocks of connections is not required, then the required number of connections entries will simply be the number of connections to be monitored. A subset of the capacity of the CAM 25 may be used, using the global mask capability of the CAM 25 to ignore the unused portion of the CAM entry and comparand. FIG. 2 shows schematically the organisation of the CAM 25 in accordance with this example.

The CAM controller 24 implements a state machine to control the operations of the CAM 25. This includes initialising the CAM 25, controlling hardware-driven CAM operations (such as Learns or Compares, discussed further below) and software-driven operations (such as Reads or UnLearns, again as discussed further below).

As mentioned above, a captured data packet is pipelined whilst the extracted connection data of the data packet is passed to the CAM 25. A CAM look-up is performed on that extracted connection data so that the extracted connection data is compared with the entries in the CAM 25. An evaluation result is produced by the CAM 25. In the case of a match between the extracted connection data and connection data stored in the CAM 25, this may be regarded as a positive evaluation result. In such a case, the CAM 25 outputs a signal to the CAM controller 24 to indicate the match. The CAM controller 24 can then cause a descriptor update portion 27 of the filter 20 to tag the pipelined data packet with a descriptor containing a valid data packet indicator. The descriptor tagged to the data packet may also contain the index of the entry in the connection table provided by the CAM 25, which may be useful later for statistics analysis and reassembly of the data packets. If no match between the extracted connection data and the connection data stored in the CAM 25 is found, then, again, an evaluation result is produced. This may be regarded as a negative evaluation result, which may be in the form of the CAM 25 outputting a signal to the CAM controller 24 to indicate the failure, the CAM controller 24 then causing the descriptor update portion 27 of the filter 20 to tag the pipelined data packet with a descriptor containing an invalid cell indicator. Alternatively, the evaluation result in the case of no match may be the same as in the case of a match, with the data packet being tagged with a descriptor containing a valid data packet indicator and, optionally, the index of the entry in the connection table provided by the CAM 25 (with the possibility of other action being effected in the case of no match, as discussed further below). In any event, the pipelined data packet can then be passed to an interface 28 to downstream network monitoring logic, where statistics analysis and other network monitor functions can be carried out in a manner known per se.

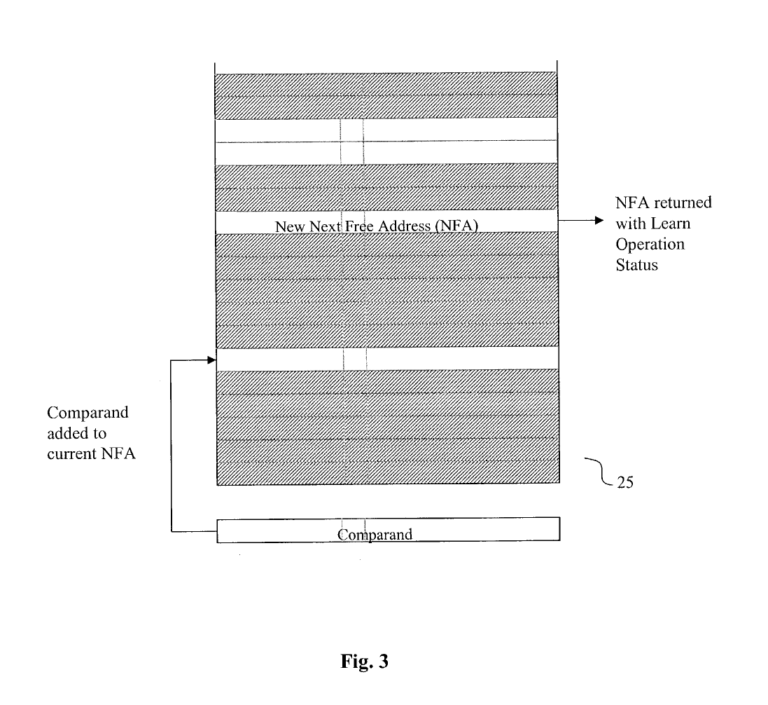

In the preferred embodiment, the filter 20 and CAM 25 are arranged to enable auto-discovery, which is a term used to describe the automatic allocations of new connections to the connection table provided by the CAM 25. This can be carried out using the Learn operation supported by the CAM 25. In particular, and referring now to FIG. 3, briefly the Learn operation can be used in the present context to allow the comparand (i.e. the connection data, which in the preferred embodiment is the VPI/VCI address pair) of a non-matched look-up to be added to the CAM 25 at the next free address available in the CAM 25. The next free address is readable from a register in the CAM 25, but it is also returned by the CAM 25 when the Learn operation adds a new entry and can be registered by the CAM controller 24.

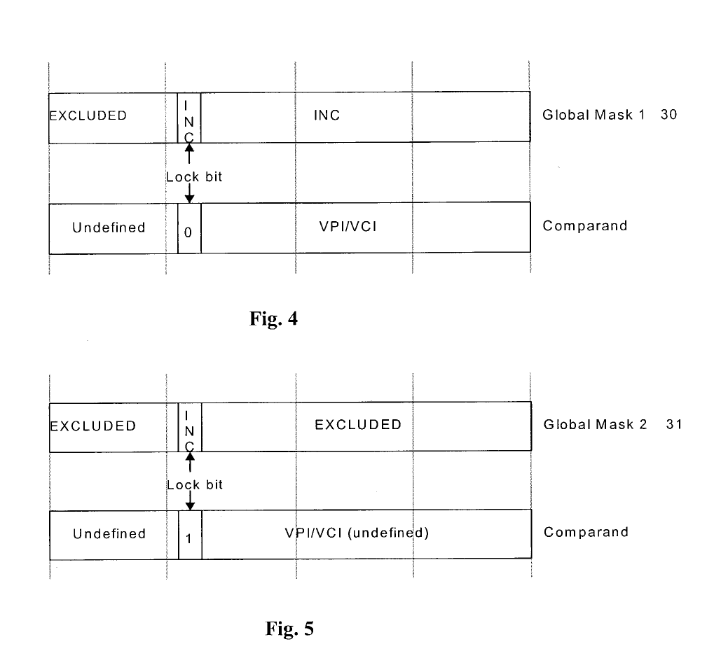

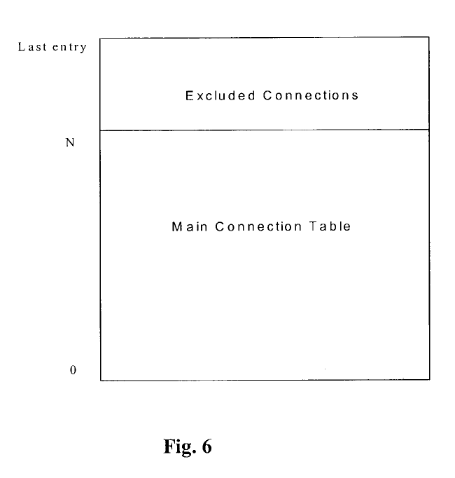

In one preferred implementation of this hardware-driven auto-discovery process, operation is as follows. Referring to FIG. 4, the extracted connection data is pre-pended with a zero in the lock bit location. A global mask register 30, which may be pre-stored in the memory register 26 of the filter 20, is used to mask the rest of the stored data in each location in the CAM 25 during the match look-up process. If the look-up returns a match, then the address that is returned can be used as the connection table ID, and added to a descriptor tagged to the data packet for downstream logic cross-referencing. By way of example, this ID can be used in a frame reassembly process which is carried out downstream. If on the other hand the look-up returns no match, then the previously saved next free address is the connection table ID for the new connection which is added to the descriptor. In either case, the connection table ID can also be made available to the host software so that the host software can make a software copy of the connection table if necessary or desired.

In this way, the first instance of a data packet on a new active connection is added to the connection table provided by the CAM 25 solely under hardware control, and can be processed by downstream logic for statistics, capture or other purposes. It should be noted that once the connection table is full, the Learn operation returns a full status on unmatched compares, effectively preventing new connections being added to the connection table until some entries in the connection table are cleared.

Since the auto-discovery process described above operates on a “first seen” basis, it may be desirable to pre-allocate certain connections that are of particular interest so that data packets on those connections will be filtered. This operation is termed “directed-mode discovery” which, in the present embodiment, is a software-driven allocation of connections to the connection table. Directed-mode discovery can be achieved under host software control, typically by manual user selection of the connections of interest, the host software directing the CAM controller 24 to update the next free address of the CAM 25 with connection data relating to the connection(s) of interest. This updating of the CAM 25 can be carried out at any stage, including initially and/or interleaved between the normal look-up/Learn operations described above.

It may be desirable to reserve entries in the CAM 25 in order to reserve filter space for future directed-mode discovery. This can be carried out using the lock bit described above. This bit is treated as a high-order address bit which pre-pends the connection data. During the CAM initialisation process, the required number of reserved entries in the CAM 25 are updated with the Lock bit set to 1 using the CAM Write operation; the connection data (here, the VPI/VCI address pair) setting is not important. The Lock bit is included in each look-up into the CAM 25. Normal look-ups will have the extracted VPI/VCI address pair or other connection data pre-pended by zero (i.e. there is a zero in the Lock bit compare position) to ensure no match occurs with the data in these reserved connections. Referring to FIG. 5, a look-up to determine whether there is a free address within the reserved connection pool can be performed using a second Global Mask register 31, which excludes bits from the compare except the Lock bit. This look-up will return the next free locked entry. This entry can then be written directly with the required directed-mode VPI/VCI address and unlocked. When the reserved pool is used up, further entries may be locked by reading the Next Free Address register and setting the lock bit if entries are available. It is not necessary to have the reserved pool contiguous. It is also possible to create available entries by deleting or ageing out other entries and overwriting.

There may be certain connections that contain data of no interest in the statistics and capture processes and which may therefore be excluded from the auto-discovery process. As shown schematically, this can be done simply by dividing the CAM into two regions: entries with an index in the region 0-N are for valid connections, and in the region N+1—last are for excluded connections. At initialisation, the exclude region is locked as described above. Connections that are to be excluded are added to the excluded connection region by a directed-mode type operation, and it is the responsibility of the software to manage this region. When a look-up returns a match with an index in this region, the data packets are discarded from the downstream data-flow or marked as invalid in the descriptor tag.

Entries in the connection table may become out of date, for example when a connection becomes inactive. These can be removed using the “Unlearn” operation of the CAM 25. Ageing algorithms can be implemented, in software or hardware, to trigger this function. Alternatively, an active connection which has been auto-discovered may be categorised as unwanted and transferred to an Excluded connection region of the CAM 25 by first adding it to the Exclude region and then removing it from the valid connection region with the use of the “Unlearn” operation.

Embodiments of the present invention have been described with particular reference to the examples illustrated. However, it will be appreciated that variations and modifications may be made to the examples described within the scope of the present invention.

What is claimed is:

1. A method for enabling filtering of data packets passing along a data link, wherein each data packet to be filtered includes connection data relating to the source of the data packet and the destination of the data packet, the method comprising:
for at least some of said data packets passing along a data link, comparing in a hardware logic device the connection data of the data packets with connection data stored in the hardware logic device; and,
generating a positive evaluation result for any packet for which the connection data of said data packet matches any of the connection data stored in the hardware logic device, whereby said data packet can be filtered.

2. A method according to claim 1, comprising, for a packet whose connection data does not match connection data that has been previously stored in the hardware logic device, adding connection data for said packet to the connection data stored in the hardware logic device.

3. A method according to claim 2, comprising generating an evaluation result for a packet whose connection data does not match connection data that has been previously stored in the hardware logic device and for which connection data has as a result been added to the connection data stored in the hardware logic device.

4. A method according to claim 1, wherein at least some memory space of the hardware logic device is initially reserved, and comprising saving connection data to some of said initially reserved memory space.

5. A method according to claim 1, comprising removing from the hardware logic device at least some of the connection data stored therein.

6. A method according to claim 1, wherein the step of generating an evaluation result for a packet comprises tagging said data packet with a corresponding descriptor.

7. A method according to claim 6, wherein the descriptor includes address data for the connection data stored in the hardware logic device that corresponds to the connection data of said data packet.

8. A method according to claim 1, wherein the hardware logic device comprises a content addressable memory.

9. A method according to claim 1, wherein the data packets comprise ATM (asynchronous transfer mode) packets and the connection data comprises a virtual channel and a virtual circuit address pair.

10. A method of filtering of data packets passing along a data link, wherein each data packet to be filtered includes connection data relating to the source of the data packet and the destination of the data packet, the method comprising:
capturing one of the data packets;
comparing in a hardware logic device the connection data of the captured data packet with connection data stored in the hardware logic device; and,
if the connection data of said data packet matches any of the connection data stored in the hardware logic device, tagging the captured data packet with a corresponding descriptor; or
if the connection data of said data packet does not match any of the connection data stored in the hardware logic device, adding the connection data of said data packet to the hardware logic device and tagging the captured data packet with a corresponding descriptor.

11. A method according to claim 10, wherein at least some memory space of the hardware logic device is initially reserved, and comprising saving connection data to some of said initially reserved memory space.

12. A method according to claim 10, comprising removing from the hardware logic device at least some of the connection data stored therein.

13. A method according to claim 10, wherein the hardware logic device comprises a content addressable memory.

14. A method according to claim 10, wherein the data packets comprise ATM (asynchronous transfer mode) packets and the connection data comprises a virtual channel and a virtual circuit address pair.

15. Apparatus for enabling filtering of data packets passing along a data link, wherein each data packet to be filtered includes connection data relating to the source of the data packet and the destination of the data packet, the apparatus comprising:
a hardware logic device for storing connection data;
a connection data extractor for extracting connection data from a data packet passing along a data link;
the hardware logic device being constructed and arranged to compare the extracted connection data with connection data stored in the hardware logic device; and,
a result generator constructed and arranged to generate a positive evaluation result for any packet for which the connection data of said data packet matches any of the connection data stored in the hardware logic device, whereby said data packet can be filtered.

16. Apparatus according to claim 15, wherein the hardware logic device is constructed and arranged to add to the connection data stored in the hardware logic device connection data for a packet whose connection data does not match connection data that has been previously stored in the hardware logic device.

17. Apparatus according to claim 16, wherein the hardware logic device is constructed and arranged to generate an evaluation result for a packet whose connection data does not match connection data that has been previously stored in the hardware logic device and for which connection data has as a result been added to the connection data stored in the hardware logic device.

18. Apparatus according to claim 15, wherein the hardware logic device is constructed and arranged so that at least some memory space of the hardware logic device can initially be reserved such that connection data can subsequently be saved to some of said initially reserved memory space.

19. Apparatus according to claim 15, wherein the result generator is constructed and arranged to tag a data packet with a corresponding descriptor to indicate an evaluation result for said packet.

20. Apparatus according to claim 19, wherein the result generator is constructed and arranged such that the descriptor that is tagged to a data packet includes address data for the connection data stored in the hardware logic device that corresponds to the connection data of said data packet.

21. Apparatus according to claim 15, wherein the hardware logic device comprises a content addressable memory.

22. Apparatus for filtering of data packets passing along a data link, wherein each data packet to be filtered includes connection data relating to the source of the data packet and the destination of the data packet, the apparatus comprising:
a device constructed and arranged to capture one of the data packets;
a hardware logic device in which connection data can be stored, the hardware logic device being constructed and arranged to compare the connection data of the captured data packet with connection data stored in the hardware logic device; and,
a data packet tagging device constructed and arranged to tag a captured data packet with a corresponding descriptor if the connection data of said captured data packet matches any of the connection data stored in the hardware logic device, and to add the connection data of a captured data packet to the hardware logic device and to tag said captured data packet with a corresponding descriptor if the connection data of said captured data packet does not match any of the connection data stored in the hardware logic device.

23. Apparatus according to claim 21, wherein the hardware logic device is constructed and arranged so that at least some memory space of the hardware logic device can initially be reserved such that connection data can subsequently be saved to some of said initially reserved memory space.

24. Apparatus according to claim 22, wherein the hardware logic device comprises a content addressable memory.
